(19) United States
(12) Patent Application Publication
(10) Pub. No.: US 2016/0093307 A1
(43) Pub. Date: Mar. 31, 2016

(54) Latency Reduction

(71) Applicant: Audience, Inc., Mountain View, CA (US)

(72) Inventors: Niel D. Warren, Soquel, CA (US); Sean Mahnken, Mountain View, CA (US)

(21) Appl. No.: 14/866,304

(22) Filed: Sep. 25, 2015

Related U.S. Application Data
(60) Provisional application No. 62/055,563, filed on Sep. 25, 2014.

(51) Int. Cl. G10L 19/002

(52) U.S. Cl. CPC G10L 19/002

(57) ABSTRACT

Provided are systems and methods for reducing end-to-end latency. An example method includes configuring an interface, between a codec and a baseband or application processor, to operate in a burst mode. Using the burst mode, a transfer of real-time data is performed between the codec and the baseband or application processor at a high rate. The high rate is defined as rate faster than a real-time rate. The exemplary method includes padding data in a time period remaining after the transfer, at the high rate, of a sample of the real-time data samples. The padded of the data may be configured such that data can be ignored by the receiving component. The interface can include a Serial Low-power Inter-chip Media Bus (SLIMBus). Power consumption may be reduced for the SLIMBus by utilizing the gear shifting or clock stopping SLIMbus features.

### CROSS-REFERENCE TO RELATED APPLICATION

The present application claims the benefit of U.S. Provisional Application No. 62/055,563, filed on Sep. 25, 2014. The subject matter of the aforementioned application is incorporated herein by reference for all purposes.

### FIELD

The present application relates generally to audio processing and, more specifically, to systems and methods for reducing latency in audio processing.

### BACKGROUND

Advantages in technology have resulted in a variety of computing devices allowing voice communications and receiving audio and video over a network. Processing audio data involves transferring data between different electronic components within a computing device such as, but not limited to, baseband, application processors, codec, radio transmitting modules, microphones, speakers and so forth. The electronic components are communicatively coupled using one or more interfaces to perform functionalities of computing devices including receiving and processing audio signals.

Serial Low-power Inter-chip Media Bus (SLIMBus) is a standard interface for connection of baseband and application processors and codecs in various mobile devices. The codec provides compression/decompression in order to represent a high-fidelity audio signal with the minimum number of bits while retaining the quality. The compression/decompression reduces the storage and the bandwidth required for transmission of audio The baseband, also referred to herein as the baseband processor, is a chipset mainly used to process all radio communication functions in the mobile device. The application processor generally provides the processing necessary to provide various mobile computing functions.

Audio data from the codec to the baseband or application processor is typically transferred via the SLIMBus at a real-time rate. This results in substantial additional end-to-end latency in both directions for transferring the audio data. The substantial additional end-to-end latency can result in poor quality voice communications.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Systems and methods for reducing end-to-end latency are provided. The method includes configuring an interface between a first and second components of a mobile device to operate in a burst mode; using the burst mode, performing a transfer of real-time data between the first and second components at a high rate, the high rate being faster than a real-time rate; and padding data in a time period remaining after the transfer at the high rate of the real-time data.

In various embodiments of the method and corresponding system, the interface includes a Serial Low-power Inter-chip Media Bus (SLIMBus) and the high rate is, for example, 8 times faster than the real-time rate.

The first component may be a codec and the second component may be at least one of a baseband processor or an application processor. In some embodiments, the transfer of the real-time data is performed from the codec to the baseband processor or from the baseband processor to the codec. The real-time data can comprise real-time data samples of an audio signal. In some embodiments, the audio signal is an audio stream which has been sampled to form the real-time data samples.

The padding may be configured such that the padded data can be disregarded or ignored by the receiving one of the first and second components. In some embodiments, the data is padded in the time period remaining after the transfer at the high rate of each sample of the real-time data samples of an audio stream.

According to another example embodiment of the present disclosure, the steps of the method for reducing end-to-end latency are stored on a non-transitory machine-readable medium comprising instructions, which when implemented by one or more processors perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram of example system in which the present technology is used, according to an example embodiment.

FIG. 2 is a block diagram showing transferring data between the codec and the baseband in two transfer modes, according to an example embodiment.

FIG. 3 is a flow chart showing a method for reducing end-to-end latency, according to an example embodiment.

FIG. 4 is a computer system which can be used to implement methods of the present technology, according to various example embodiments.

### DETAILED DESCRIPTION

The technology disclosed herein relates to systems and methods for reducing of end-to-end latency. Embodiments of the present technology may be practiced with any audio device configured to receive and/or provide audio such as, but not limited to, cellular phones, phone handsets, headsets, and conferencing systems. It should be understood that while some embodiments of the present technology will be described in reference to operations of a cellular phone, the present technology may be practiced with any audio device.

Audio devices can include: radio frequency (RF) receivers, transmitters, and transceivers; wired and/or wireless telecommunications and/or networking devices; amplifiers; audio and/or video players; encoders; decoders; speakers; inputs; outputs; storage devices; user input devices. Audio devices may include input devices such as buttons, switches, keys, keyboards, trackballs, sliders, touchscreens, one or more microphones, gyroscopes, accelerometers, global positioning system (GPS) receivers, and the like. Audio devices can include output devices, such as LED indicators, video displays, touchscreens, speakers, and the like. In some embodiments, mobile devices can include hand-held devices, such as wired and/or wireless remote controls, notebook computers, tablet computers, phablets, wearable device, smart phones, personal digital assistants, media players, mobile telephones, and the like.

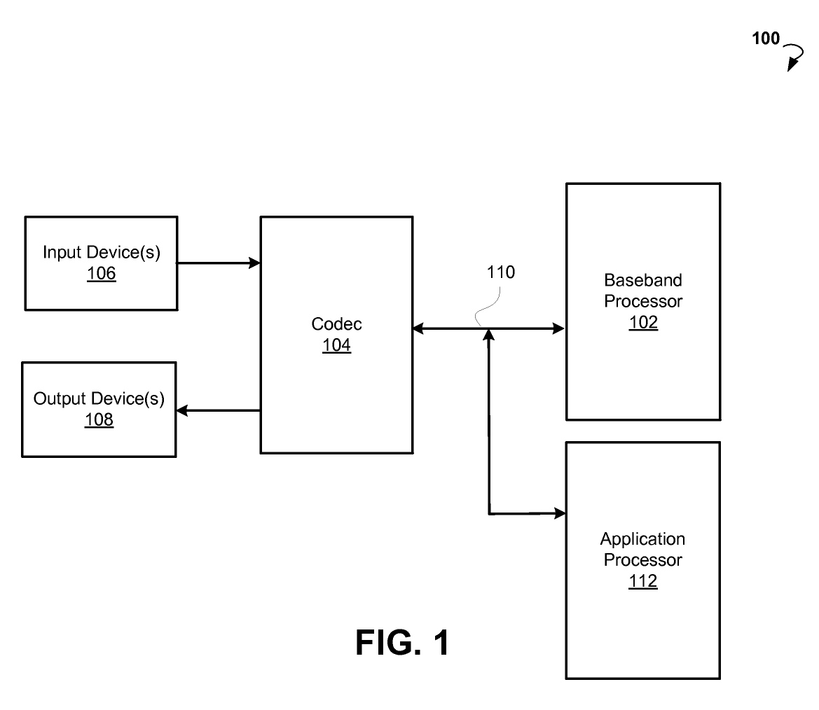

Referring now to FIG. 1, an example system 100 is shown in which a method for reducing end-to-end latency can be practiced. The example system 100 includes at least a baseband (processor) 102, an application processor 112, and a codec 104. The baseband 102, application processor, and codec 104 can be communicatively coupled via an interface 110. The baseband 102 and application processor 112 may be integrated as a single component. FIG. 1 illustrates example connections, other suitable connections may be used consistent with the present disclosure.

In various embodiments, the interface 110 includes a Serial Low-power Inter-chip Media Bus (SLIMbus). The SLIMbus is a standard interface between baseband or application processors and peripheral components (e.g., codecs) in various mobile devices. The SLIMbus interface supports many digital audio components simultaneously, and carries multiple digital audio data streams at differing sample rates and bit widths. For the SLIMbus interface, both a Data (DATA) and clock (CLK) may be used to synchronize with the bus configuration in use, to receive or transmit messages and data, and to implement bus arbitration, collision detection, and contention resolution between devices. The SLIMbus interface can operate bidirectionally for data transfer.

In various embodiments, the system 100 includes one or more input devices 106 and one or more output devices 108. In some example embodiments, the input devices 106 includes one or more microphones for capturing acoustic signal. The captured acoustic signal is provided to the codec 104 for processing. In various embodiments, the output devices 108 include headset, speakers, and so forth. The output devices 108 are configured to play back an audio received from the codec 104.

The elements of the example system 100 are typically found in audio devices, such as cellular phone, smart phones, tablet computers, notebooks, desktop computers, wireless headsets and other wearable devices, and speakers. The system 100 is used for transferring data, for example, during a voice communication via the audio devices.

During voice communication, at one end, the acoustic signal captured by input devices 106 (microphones) is provided to codec 104 for digital processing. The signal processed by codec 104 is transmitted via the interface 110 to baseband 102 (and to the application processor 112 in some embodiments) for further processing and transferring. At another end, the output of the baseband 102 is transmitted to codec 104. The codec 104 processes the baseband output to generate an audio and to provide the audio to output devices 108.

In some embodiments, the application processor is also coupled to the codec via the interface 110 for providing various processing and control. Although certain data transfers may be described herein with respect to transfer between the codec 104 and baseband 102, one of ordinary skill would appreciate that a suitable transfer of data may also be made to/from the application processor 112, in accordance with the present disclosure.

Regular data transfer between codec 104 and baseband 102 involves repeatedly sending a first buffer from codec 104 to the baseband 102 and sending a second buffer from the baseband 102 back to the codec 104. In isochronous transfer mode, the first buffer is equal to the second buffer. Regularly, the first buffer and the second buffer represent a time period of an audio signal in a real time. Therefore an inherent latency is present when transferring data in each direction. During a real time voice communication, the latency can lead to worsening of voice quality in transferring audio signals since the audio signals are transferred at a real-time rate.

In some embodiments, the latency is reduced by speeding up the data transfer between the codec and baseband while keeping the architecture on both sides the same, so the data are transferred faster than real time. The reduction of the latency can improve the quality of the voice communication.

In some embodiments, the transfer protocol used in communications between codec 104 and baseband 102 is changed to use the same isochronous mode of interface 110, but transfers the data 8 times faster than a current transfer rate.

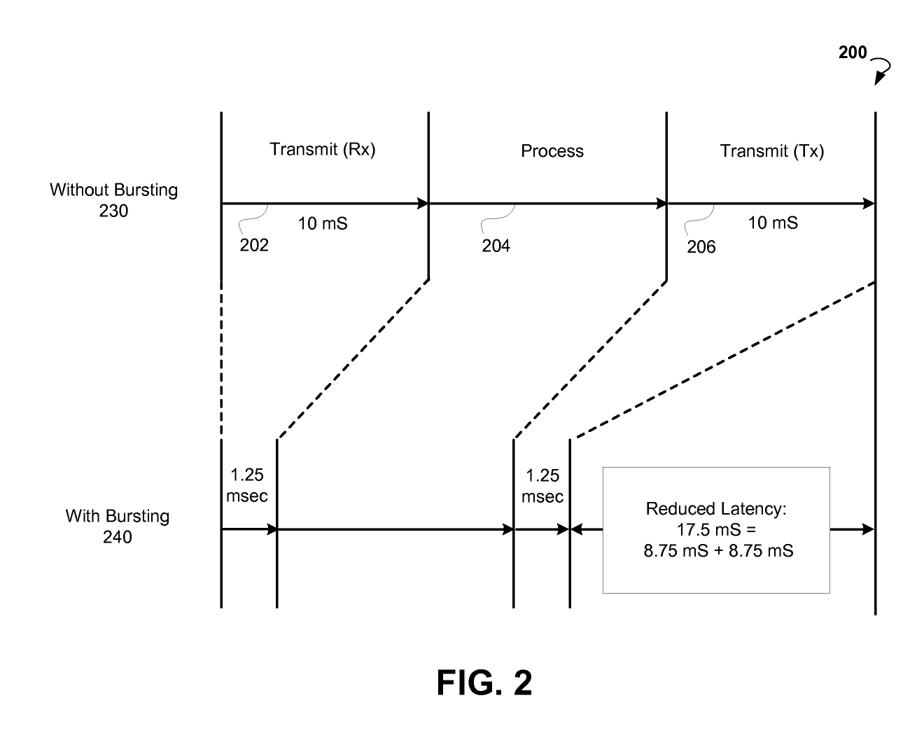

FIG. 2 is a block diagram showing example 200 of transferring data between baseband 102 and codec 104 in two transfer modes, according to an example embodiment. In example of FIG. 2, the mode (“without bursting”) 230 is a regular transfer mode (without bursting) of interface 110 that corresponds to a regular data transfer in real time. The baseband 102 receives a first buffer corresponding to 10 milliseconds (msec) of real-time audio data, thus the “transmit (Rx)” transfer time interval 202 for the first buffer is 10 msec. Baseband 102 processes the received audio data for a time period 204. The baseband 102 further transmits a second buffer corresponding to 10 msec of real-time audio data back to the codec 104, thus the “Transmit (Tx)” transfer time interval 206 for the second buffer is 10 msec. Therefore, receiving of the next buffer from the codec 104 is delayed by 10 msec.

The mode (“with bursting”) 240 is a transfer mode with bursting (a burst mode). During the burst mode, data transfer rate is 8 times faster than a regular transfer mode 230 (e.g., 8 times faster than the regular “no bursting” mode). The audio data that correspond to 10 msec of real time are transferred in 1.25 msec. The latency of 10 msec is reduced by 8.75 msec on both ends, thereby resulting in a total reduction in latency (“reduced latency”) of 17.5 msec.

Both the codec 104 and baseband 102 receive the 10 msec real time audio data in 1.25 msec. The audio data become available to either baseband 102 or codec 104 in first 1.25 msec of transfer. In some embodiments, the buffer containing remaining 8.75 msec is padded. The padded data can be disregarded or ignored when received by the codec 104 or the baseband 102.

Running the data streams 8 times faster than real-time forces a higher gear for SLIMbus. 384 kHz is required for two channels at 8 kHz each for 16-bit samples. 3.072 MHz is required for two channels at 64 kHz each for 16-bit samples. The difference is 3072 kHz−384 kHz=2.688 MHz, which is a number of extra cycles on the SLIMbus for a 30 pF bus. Performing the extra cycles at 1.8 V results in 260 uW of power wasted.

For the exemplary SLIMbus interface, the SLIMbus CLK line frequency is determined by a range of “root” clock frequencies up to 28 MHz, and 10 clock “gears” for altering the clock frequency by powers of 2 over a span of 512× from lowest to highest gear. For the SLIMport interface, the root frequency is typically defined as 2^{(10-G)} times the frequency of the CLK line. For G=10, the CLK line frequency and root frequency would be equal. SLIMbus CLK frequencies and data transport protocols typically support all common digital audio converter over-sampling frequencies and associated sample rates.

In addition to control over the clock frequency (e.g., via the gears), the SLIMbus CLK may also be stopped and restarted. In some embodiments, the additional power consumption is partially mitigated by utilizing at least one gear provided by the SLIMbus to alter the clock frequency for the time period where data is padded.

In other embodiments, power consumption is reduced by utilizing a clock stop feature of SLIMBus for the time period where data is padded.

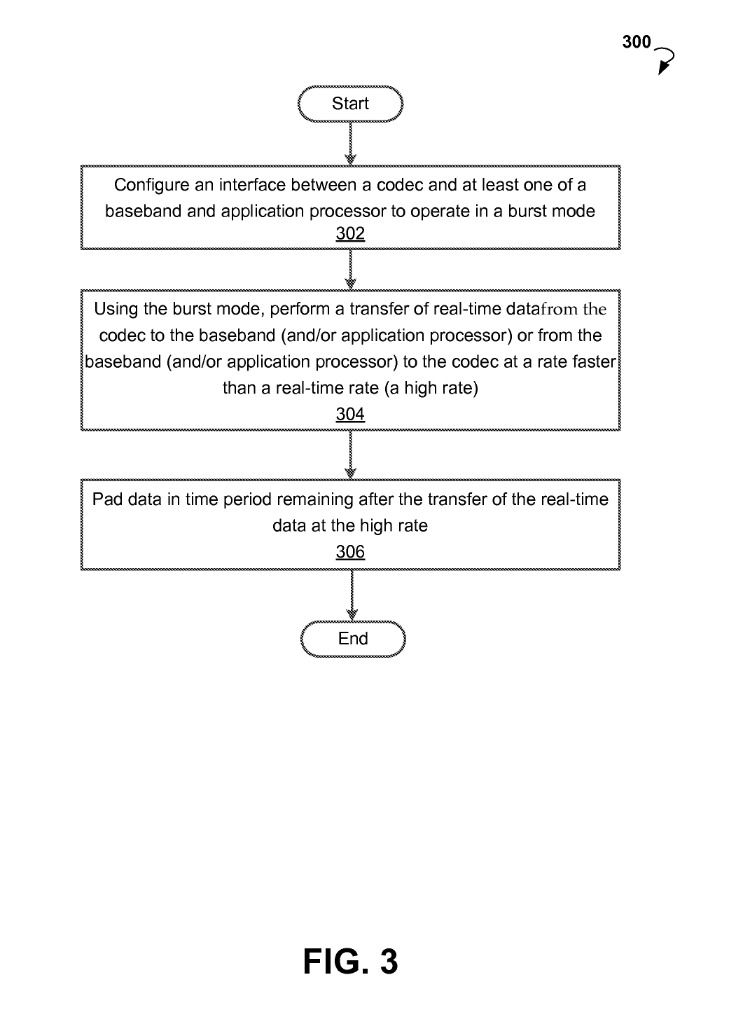

FIG. 3 is flow chart diagram showing a method 300 for reducing end-to-end latency, according to an example embodiment. Method 300 can commence in block 302 with configuring an interface between components (e.g., between the codec and one or both of the baseband and application processor) to operate in a burst mode.

In block 304, using the burst mode, a transfer of real-time data is performed from the codec to the baseband (and/or application processor) or from the baseband (and/or application processor) to the codec at a rate faster than a real-time rate (a high rate).

In block 306, data are padded in time period remaining after the transfer of the real-time data at the high rate. In some embodiments, the data being transferred comprises samples of a sampled audio stream; the data being padded in the time period remaining after the transfer at the high rate of each sample of the real-time data samples of the audio stream.

In various embodiments, the padding is configured such that the padded data can be disregarded (or ignored) by the receiving one of the components.

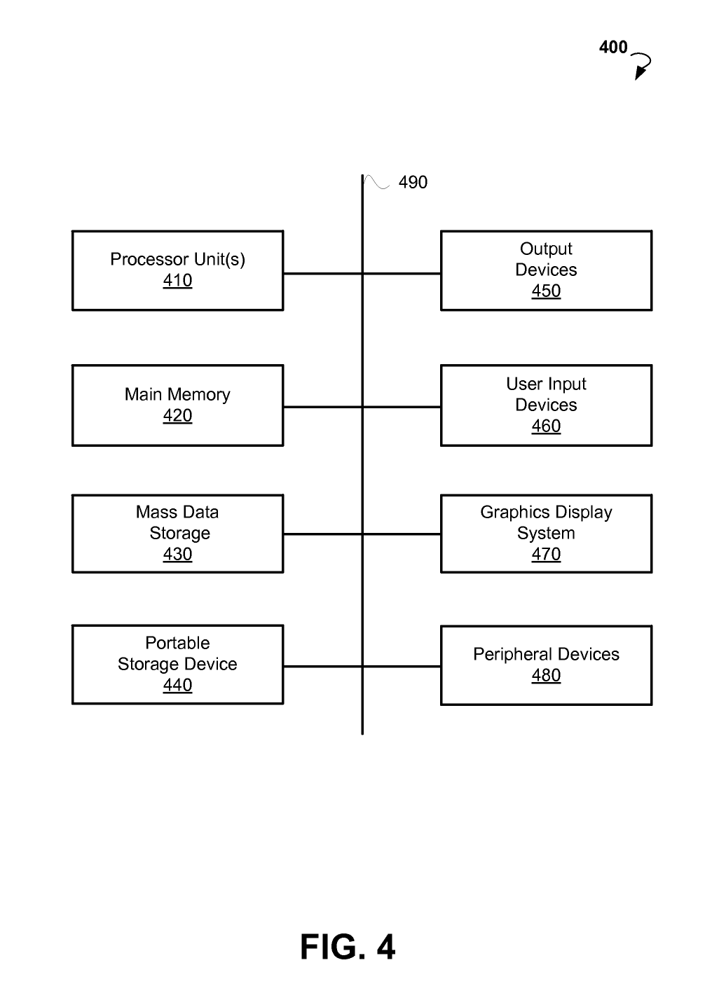

FIG. 4 illustrates an exemplary computer system 400 that may be used to implement some embodiments of the present invention. The computer system 400 of FIG. 4 may be implemented in the contexts of the likes of computing systems, networks, servers, or combinations thereof. The computer system 400 of FIG. 4 includes one or more processor unit(s) 410 and main memory 420. Main memory 420 stores, in part, instructions and data for execution by processor unit(s) 410. Main memory 420 stores the executable code when in operation, in this example. The computer system 400 of FIG. 4 further includes a mass data storage 430, portable storage device 440, output devices 450, user input devices 460, a graphics display system 470, and peripheral devices 480.

The components shown in FIG. 4 are depicted as being connected via a single bus 490. The components may be connected through one or more data transport means. Processor unit 410 and main memory 420 is connected via a local microprocessor bus, and the mass data storage 430, peripheral device(s) 480, portable storage device 440, and graphics display system 470 are connected via one or more input/output (I/O) buses.

Mass data storage 430, which can be implemented with a magnetic disk drive, solid state drive, or an optical disk drive, is a non-volatile storage device for storing data and instructions for use by processor unit 410. Mass data storage 430 stores the system software for implementing embodiments of the present disclosure for purposes of loading that software into main memory 420.

Portable storage device 440 operates in conjunction with a portable non-volatile storage medium, such as a flash drive, floppy disk, compact disk, digital video disc, or Universal Serial Bus (USB) storage device, to input and output data and code to and from the computer system 400 of FIG. 4. The system software for implementing embodiments of the present disclosure is stored on such a portable medium and input to the computer system 400 via the portable storage device 440.

User input devices 460 can provide a portion of a user interface. User input devices 460 may include one or more microphones, an alphanumeric keypad, such as a keyboard, for inputting alphanumeric and other information, or a pointing device, such as a mouse, a trackball, stylus, or cursor direction keys. User input devices 460 can also include a touchscreen. Additionally, the computer system 400 as shown in FIG. 4 includes output devices 450. Suitable output devices 450 include speakers, printers, network interfaces, and monitors.

Graphics display system 470 include a liquid crystal display (LCD) or other suitable display device. Graphics display system 470 is configurable to receive textual and graphical information and processes the information for output to the display device.

Peripheral devices 480 may include any type of computer support device to add additional functionality to the computer system.

The components provided in the computer system 400 of FIG. 4 are those typically found in computer systems that may be suitable for use with embodiments of the present disclosure and are intended to represent a broad category of such computer components that are well known in the art. Thus, the computer system 400 of FIG. 4 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 400 is implemented as a cloud-based computing environment, such as a virtual machine operating within a computing cloud. In other embodiments, the computer system 400 may itself include a cloud-based computing environment, where the functionalities of the computer system 400 are executed in a distributed fashion. Thus, the computer system 400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 400, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

1. A method for reducing end-to-end latency, the method comprising:
configuring an interface between a first and second components of a mobile device to operate in a burst mode;
using the burst mode, performing a transfer of real-time data between the first and second components at a high rate, the high rate being faster than a real-time rate; and
padding data in a time period remaining after the transfer at the high rate of the real-time data.

2. The method of claim 1, wherein the first component comprises a codec and the second component comprises at least one of a baseband processor or an application processor.

3. The method of claim 2, wherein the transfer of the real-time data is performed from the codec to the baseband processor or from the baseband processor to the codec.

4. The method of claim 1, wherein the padding is configured such that the padded data can be disregarded by the receiving one of the first and second components.

5. The method of claim 1, wherein the real-time data comprise real-time data samples of an audio signal.

6. The method of claim 5, wherein the data is padded in the time period remaining after the transfer at the high rate of each sample of the real-time data samples of an audio stream.

7. The method of claim 5, wherein the transfer of the real-time data at the high rate is performed to improve voice quality during a voice communication.

8. The method of claim 1, wherein the interface is configured to operate in an isochronous mode.

9. The method of claim 1, wherein the high rate is 8 times faster than the real-time rate.

10. The method of claim 1, wherein the interface includes a Serial Low-power Inter-chip Media Bus (SLIMBus).

11. The method of claim 10, further comprising reducing power consumption of the SLIMBus by utilizing at least one gear provided by the SLIMbus to alter the clock frequency for the time period where data is padded.

12. The method of claim 10, further comprising reducing power consumption of the SLIMBus by utilizing a clock stop feature of SLIMBus for the time period where data is padded.

13. A system for reducing end-to-end latency, the system comprising:
at least one processor; and
a memory communicatively coupled with the at least one processor, the memory storing instructions, which when executed by the at least processor performs a method comprising:
configuring an interface between a first and second components of a mobile device to operate in a burst mode;
using the burst mode, performing a transfer of real-time data between the first and second components at a high rate, the high rate being faster than a real-time rate; and
padding data in a time period remaining after the transfer at the high rate of the real-time data.

14. The system of claim 13, wherein the first component comprises a codec and the second component comprises at least one of a baseband processor or an application processor.

15. The system of claim 14, wherein the transfer of the real-time data is performed from the codec to the baseband processor or from the baseband processor to the codec.

16. The system of claim 13, wherein the padding is configured such that the padded data can be disregarded by the receiving one of the first and second components.

17-20. (canceled)

21. The system of claim 13, wherein the real-time data comprise real-time data samples of an audio signal and wherein the data is padded in the time period remaining after the transfer at the high rate of each sample of the real-time data samples of the audio signal.

22. The method of claim 1, wherein the interface includes a Serial Low-power Inter-chip Media Bus (SLIMBus) and wherein the high rate is 8 times faster than the real-time rate.

23. A non-transitory computer-readable storage medium having embodied thereon instructions, which when executed by at least one processor, perform steps of a method, the method comprising:
configuring an interface between a first and second components of a mobile device to operate in a burst mode;
using the burst mode, performing a transfer of real-time data between the first and second components at a high rate, the high rate being faster than a real-time rate; and
padding data in a time period remaining after the transfer at the high rate of the real-time data.
